(19) United States
(12) Patent Application Publication
(10) Pub. No.: US 2011/0115133 A1
(43) Pub. Date: May 19, 2011

(54) METHOD FOR MAKING PLASTIC TOOLING

(76) Inventor: Daniel R. Seward, Hazel Park, MI (US)

(21) Appl. No.: 12/944,128

(22) Filed: Nov. 11, 2010

Related U.S. Application Data
(60) Provisional application No. 61/261,474, filed on Nov. 16, 2009.

(51) Int. Cl. B29C 39/38; B29C 39/02

(52) U.S. Cl. 264/489; 264/101

(57) ABSTRACT

A method for making plastic tooling used in vinyl and plastic forming in which a model is first positioned within a container. The container is filled at least partially with a mixture of granular material and epoxy and the container is then positioned within a flexible bag. A vacuum is applied to the bag thus compressing the mixture of granular material and epoxy against the model. After the epoxy has set, the container is removed from the bag and the now set or cured mixture of granular material and epoxy which forms the plastic tooling is removed from the model and thereafter used in vinyl and plastic forming and other operations.

### CROSS REFERENCE TO RELATED APPLICATION

This application claims priority of U.S. Provisional Patent Application Ser. No. 61/261,474 filed Nov. 16, 2009, which is incorporated herein by reference.

### BACKGROUND OF THE INVENTION

I. Field of the Invention

The present invention relates to a method for making plastic tooling, especially plastic tooling used in vinyl forming.

II. Description of Related Art

Plastic tooling for forming plastic parts, such as vinyl parts, is widely used throughout the industry. For example, such plastic parts are widely used in the automotive industry for dashboards and other interior and exterior trim parts. Such plastic tooling is typically formed from a pattern or model which is then used in RIM, RTM, injection molding, or the like to form the final part.

Plastic tooling has enjoyed increased popularity in recent years due to the economical and efficient construction of such plastic tooling. For example, one type of previously known plastic tooling included laminated plastic tools that are made of alternating layers of fiberglass cloth and liquid laminating plastic. After the laminations have been completed, the liquid plastic solidifies into a strong rigid form to form the plastic tooling.

In another type of plastic tooling, a surface cast tool includes a metallic core which is cast to the general shape of the finished tool. The core is then suspended over a model of the working surface of the tool and a liquid plastic is cast into the space between the model and the metal core to form the plastic tooling.

One of the disadvantages with the previously known methods for constructing plastic tooling resides in the buildup of exothermic heat which limits the tools to about 4 inches in thickness unless special means are provided to reduce the heat buildup during the tool manufacturing operation. Such heat removing means, however, further increase the complexity and cost of the plastic tooling.

A still further problem with the previously known plastic tooling, and particularly relatively large plastic tooling, is thermal shrinkage of the plastic tooling during the manufacturing process for constructing the plastic tooling. Such shrinkage not only results in inaccuracies in the final plastic tooling, but can also create flaws in the surface of the plastic tooling that are unacceptable for many applications.

A still further disadvantage of the previously known plastic tooling is that such plastic tooling is commonly used in a vacuum-forming process to form the manufactured parts. Conventionally, multiple vacuum-forming holes are formed through the surface of the plastic tool. A vacuum applied to the rear surface of the vacuum tool evacuates the air through the openings in the plastic tool. These openings in the plastic tool, however, are oftentimes visible on the finished part and thus unacceptable for many different types of manufactured parts.

### SUMMARY OF THE PRESENT INVENTION

The present invention provides a method for making a plastic tool which overcomes the above-mentioned disadvantages of the previously known processes.

A model is first placed within a container or core box. The outwardly facing surface of the model conforms to the desired shape of the part that will be manufactured using the plastic tooling.

The model is then coated with a thin layer of wax and a parting agent so that the tool does not stick to the model. The model as well as the interior of the container is then coated with a liquid epoxy surface coating which forms a tacky surface on the model.

While the liquid surface coating is still tacky, a layer of a mixture of epoxy and a granular material, such as sand, is then sprinkled over the entire surface of the model so that the layer completely covers the model. This layer of epoxy and granular material mixture is then firmly pressed or tamped against the model thus eliminating all voids between the thin layer of epoxy and granular material mixture and the model face.

A mixture of the granular material and epoxy then fills the container and the container is positioned within a flexible vacuum bag. Preferably, a ply layer is positioned between the bag and the epoxy and granular material mixture to prevent adhesion between the vacuum bag and the epoxy and granular material mixture.

A vacuum is then applied to the bag thus evacuating the air within the interior of the bag. This vacuum causes the bag to uniformly compress the mixture of granular material and epoxy against the model which ensures a continuous contact of the epoxy and granular material mixture against the model. The vacuum is maintained on the vacuum bag until the epoxy has set whereupon the container is removed from the bag and the plastic tooling is separated from the model.

In practice, the formed tooling maintains sufficient porosity to allow the plastic tooling to be used in vacuum-forming processes without the necessity of adding vent openings through the tooling.

If additional compression of the vacuum bag against the plastic tooling is desired, the entire vacuum bag may be positioned within a pressurized chamber, such as a steam chamber, which effectively increases the compression of the epoxy and granular material mixture against the model. Similarly, the curing time for the epoxy and granular material mixture may be reduced by heating the container when positioned within the plastic bag by heating the granular material and epoxy mixture in any conventional fashion. If a microwave oven is utilized to heat the epoxy and granular material mixture, a small amount of conductive material, such as carbon, is preferably added to the epoxy and granular material mixture.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a side view illustrating an initial step of the method of the present invention;

FIG. 2 is a view similar to FIG. 1, but illustrating a further step;

FIG. 3 is a view similar to FIGS. 1 and 2, but illustrating a further step;

FIG. 4 is a view similar to FIGS. 1-3, but illustrating a further step; and

FIG. 5 is a view similar to FIGS. 1-4, but illustrating a final step of the present invention.

### DETAILED DESCRIPTION OF A PREFERRED EMBODIMENT OF THE PRESENT INVENTION

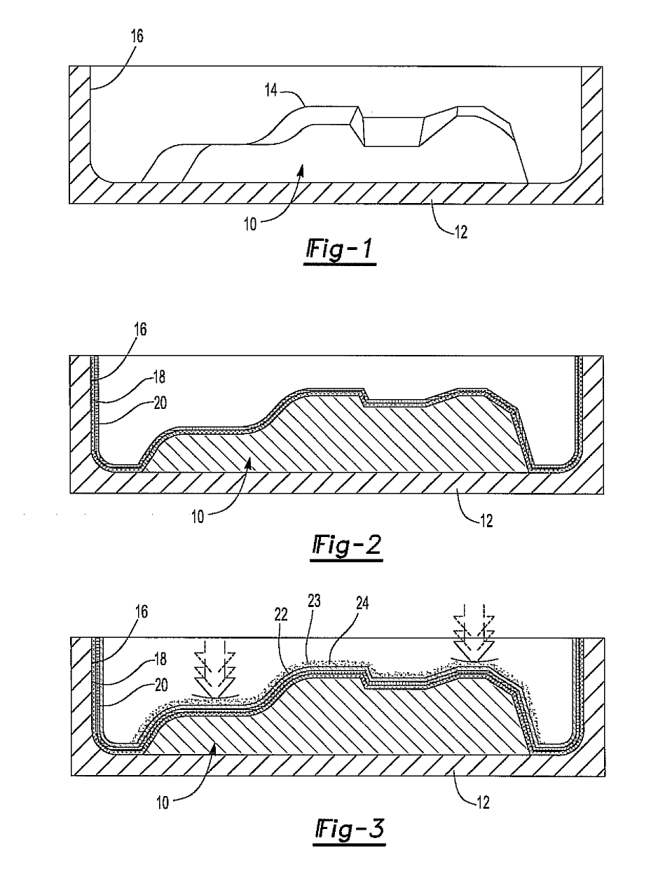

With reference first to FIG. 1, in order to manufacture the plastic tooling of the present invention, a model 10 is first positioned within a container or core box 12. The model 10 has an outwardly extending face 14 having a size and pattern which conforms to the size and pattern of the final part that will be manufactured utilizing the plastic tooling made according to the present invention.

The model 10, as well as the interior surfaces 16 of the container 12, are then covered with a wax layer 18, such as a paste wax layer. The wax layer 18 provides a smooth surface for the model 10 and also forms a parting coat. A further parting agent 20 is then applied over the entire surface of the model 10 as well as the interior surface of the box 12. Any conventional parting agent may be employed and the parting agent may be applied in any conventional method, such as spraying, brushing, wiping, or the like.

With reference now to FIG. 3, a liquid coating 22 of an epoxy material is then applied on top of the parting agent 20 in any conventional fashion, such as by brushing, wiping, or spraying. This coating 22 of the epoxy material is tacky and will remain tacky for a period of time.

While the epoxy coating 22 is still tacky, a thin layer 24 of an epoxy and granular material mixture 23 is sprinkled over the entire model 10 and manually compressed or tamped against the model 10. Such manual compression ensures a firm and continuous contact between the granular material 23 and epoxy and granular mixture thereby eliminating bridges or voids between the layer 24 of epoxy and granular material and the model 10. This layer 24 of epoxy and granular material 23, furthermore, is relatively thin, typically about one half an inch thick.

Although any granular material may be used for the epoxy and granular material mixture, preferably the granular mixture 23 comprises clean silicate sand while the epoxy is a mixture of epoxy resin and hardener. Together, the overall mixture preferably lies in the range of 5 to 15 parts of sand or granular material to 1 part of epoxy by volume.

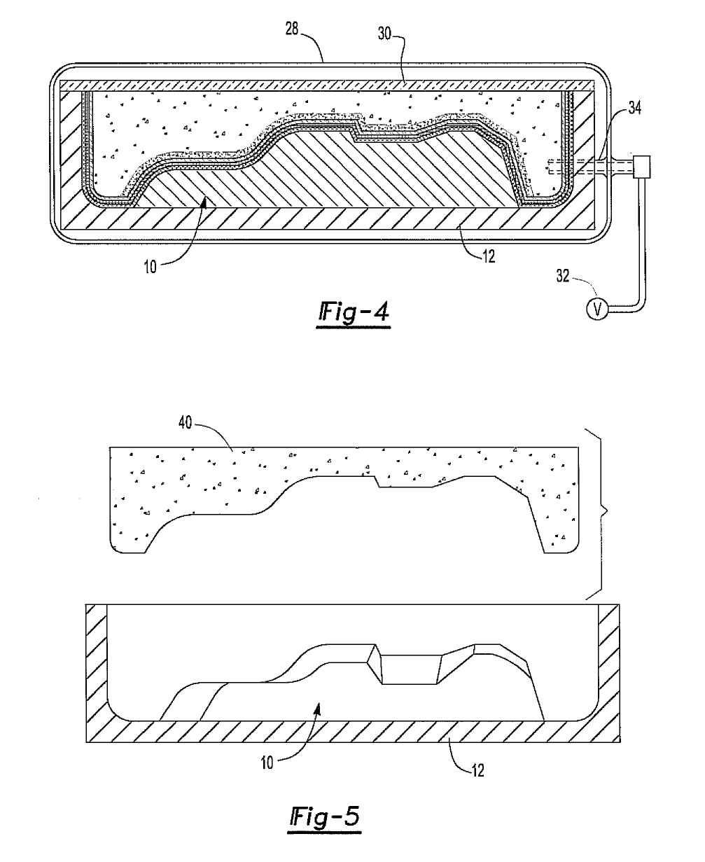

With reference now to FIG. 4, after the thin layer 24 of epoxy and granular material has been tamped against the model 10, several inches of the epoxy and granular material 23 mixture 26 is added to the container 12 so that the overall mixture 23 of granular material and epoxy is several inches thick.

The container 12 is then positioned within a vacuum bag 28. Preferably, a porous breather sheet 30 is positioned across the top of the granular material and epoxy mixture 23 and the bag 28 to prevent adhesion between the bag 28 and the epoxy and granular material mixture 23. The bag 28 is then evacuated, preferably by a vacuum pump 32 fluidly connected by a pipe 34 to the interior of the container 12.

The evacuation of the air from the bag 28 causes the bag to compress the granular and epoxy mixture 23 against the model 10. Furthermore, this pressure is evenly applied to the model 10 at a pressure of approximately 14.7 psi, i.e. atmospheric pressure.

If further compression of the granular material and epoxy mixture 23 against the model 10 is desired, the vacuum bag 38 can be positioned within a pressure chamber, such as a steam chamber, which will further increase the compression of the granular material and epoxy mixture against the model 10.

The container 12 and model 10 are maintained within the bag 28 until the epoxy in the granular material and epoxy mixture 23 has set or cured. Such curing of the epoxy in the epoxy and granular material mixture 23 is not exothermic, or at most only mildly exothermic, so that significant thermal expansion/contraction is avoided. Furthermore, in order to increase the curing rate of the epoxy in the epoxy and granular material mixture, the vacuum bag 28 with the model 10 may be positioned within a heating chamber. If a microwave is utilized as a heating chamber, preferably a conducting material, such as carbon, is intermixed into the granular material and epoxy mixture 23 in order to add some conduction to the mixture. Only 1-3 percent of carbon by volume in the mixture is required to achieve this.

After the epoxy in the epoxy and granular material mixture has cured, the container 12 with the model 10 and now cured granular material and epoxy mixture 23, the granular material and epoxy mixture is removed from the model 10 as shown in FIG. 5 and forms the plastic tooling 40 for molding and vacuum-forming operations, such as vinyl-forming operations. Furthermore, the plastic tooling 40 maintains sufficient porosity so that a vacuum can be pulled through the plastic tool without the necessity of adding vents to the plastic tooling 40.

From the foregoing, it can be seen that the present invention provides a simple and yet highly effective method for constructing plastic tooling for forming plastic parts, such as vinyl parts. Having described my invention, however, many modifications thereto will become apparent to those skilled in the art to which it pertains without deviation from the spirit of the invention as defined by the scope of the appended claims.

I claim:

1. A method for making plastic tooling comprising the steps of
placing a model in a container,
at least partially filling said container with a mixture of a granular material and an epoxy,
placing said container in a flexible bag,
applying a vacuum to said bag,
removing said container from said bag after the epoxy has cured and formed the plastic tooling, and
thereafter separating said plastic tooling from said model.

2. The method as defined in claim 1 and further comprising the step of coating said model with a parting agent prior to said step of at least partially filling said container with said mixture.

3. The method as defined in claim 2 wherein said parting material comprises a wax.

4. The method as defined in claim 1 and comprising the step of positioning a porous sheet between said mixture and said bag.

5. The method as defined in claim 1 wherein said at least partially filling step comprises the step of manually covering said model with said mixture and manually packing said mixture against said model.

6. The method as defined in claim 1 wherein said granular material comprises sand.

7. The method as defined in claim 1 and further comprising the step of heating the mixture while applying said vacuum.

8. The method as defined in claim 7 wherein said mixture includes a conductive material and wherein said heating step further comprises the step of irradiating said mixture with microwave energy.

9. The method as defined in claim 9 wherein said conductive material comprises carbon.

10. The method as defined in claim 9 wherein said mixture contains 1% to 3% by weight of carbon.

11. The method as defined in claim 1 wherein said granular material comprises silica sand.

12. The method as defined in claim 1 wherein said epoxy comprises an epoxy resin and an epoxy hardener.

13. The method as defined in claim 1 and comprising the step of pressurizing an outer surface of said bag.
